(19) United States
(12) Patent Application Publication
(10) Pub. No.: US 2005/0271226 A1
(43) Pub. Date: Dec. 8, 2005

(54) Speaker

(75) Inventors: Takehiko Tanabu, Aomori (JP); Hiroshi Yano, Mie (JP)

Correspondence Address: MCDERMOTT WILL & EMERY LLP, 600 13TH STREET, N.W., WASHINGTON, DC, 20005-3096, US

(73) Assignee: MASTSUSHITA ELECTRIC INDUSTRIAL CO.,, KADOMA-SHI, OSAKA 571-8501 (JP)

(21) Appl. No.: 10/518,904

(22) PCT Filed: May 18, 2004
(86) PCT No.: PCT/JP04/07024

§ 371 Date: Dec. 23, 2004

(30) Foreign Application Priority Data
May 19, 2003 (JP) 2003-140136

(51) Int. Cl. H04R 25/00

(52) U.S. Cl. 381/182; 381/396

(57) ABSTRACT

The present invention relates to a loudspeaker, which is used in a mobile communication device such as a portable phone and includes two loudspeakers in one casing, and provides the loudspeaker having stable characteristics (e.g., a sound-pressure frequency characteristic). According to the loudspeaker of the present invention, yoke (3A) is integrated by insert-molding in molding frame (1C). Thus, inserting variations caused by connecting variations, which is generated between the frame and the yoke in assembling a conventional loudspeaker, can be restricted.

### TECHNICAL FIELD

The present invention relates to a loudspeaker used in a mobile communication device such as a portable phone.

### BACKGROUND ART

Though a portable phone is compact, it includes a loudspeaker for calling or amplifying besides a loudspeaker for receiving voice. In particular, a small folding type device includes two loudspeaker parts within one frame because its size is restricted. The loudspeaker having such a structure is disclosed in Japanese Patent Unexamined Publication No. 2003-111194.

FIG. 4 is a sectional view of the conventional loudspeaker mentioned above, and its structure is demonstrated hereinafter with reference to the accompanying drawings. Hollow cylindrical frame 1 is made by molding resin, and has protruded section 1A, which protrudes toward an inner section through a whole circumference, in a center section of its inner circumference. An outer circumference of ring-shaped first magnet 2 is connected with protruded section 1A. Hat-shaped yoke 3 is connected with first magnet 2 at a lower surface of its outer circumference.

yoke 3 is made of magnetic material such as ion. Columnar second magnet 4 is connected with a ceiling surface of a middle section of yoke 3.

Second plate 5 is connected with a bottom of second magnet 4.

Circular first plate 6 is connected with an upper surface of first magnet 2. Circular first magnetic gap 7 is placed between an inner circumference of first plate 6 and an outer circumference of the middle section of yoke 3. Circular second magnetic gap 8 is placed between an outer wall of second plate 5 and an inner circumference of the middle section of yoke 3.

According to the structure discussed above, a first magnetic circuit is formed of first magnet 2, yoke 3, first magnetic gap 7 and first plate 6.

In addition, a second magnetic circuit is formed of second magnet 4, second plate 5, second magnetic gap 8 and yoke 3.

First diaphragm 9 is mounted at an upper opening section of frame 1. Circular first voice coil 10 is structured so as to be connected with first diaphragm 9 at its upper end, and the other end thereof is placed within first magnetic gap 7. First protector 10A is connected with at least one outer circumference of frame 1 and first diaphragm 9 so as to cover first diaphragm 9, and has a plurality of holes for sound.

Second diaphragm 11 is connected with a lower opening section of frame 1. Circular second voice coil 12 is structured so as to be connected with second diaphragm 11 at its lower end, and the other end thereof is placed within second magnetic gap 8. Second protector 13 is connected with at least one outer circumference of frame 1 and second diaphragm 11 so as to cover second diaphragm 11, and has a plurality of holes for sound.

When the loudspeakers structured mentioned above are used at a portable phone or the like, one of the loudspeakers is used as a receiver for receiving voice, and the other thereof is used for an incoming call or amplifying.

In addition, it can be used as a compact stereo loudspeaker by inputting L signals and R signals for stereo.

According to the conventional loudspeaker discussed above, yoke 3 is coupled with protruded section 1A of an inner wall of frame 1 via first magnet 2.

Therefore, while the loudspeaker is connected, the following problem may occur by an error or the like in assembling of yoke 3. In a word, sound outputs of two loudspeakers formed by two magnetic circuits become lower than initial aim of designing. To prevent it, the assembling process itself for connecting accurately becomes complicate in assembling.

The present invention restrains the connecting error mentioned above to a minimum, and provides an easy-assembling and stable-quality loudspeaker.

### SUMMARY OF THE INVENTION

The present invention provides a loudspeaker including the following elements:
a hollow frame having opening sections at its upper side and lower side;
a hat-shaped yoke whose both ends are supported by an inner wall of the frame;
a ring-shaped first magnet being coupled with a lower surface of an outer periphery of the yoke;
a columnar second magnet being coupled with an inner bottom of a middle section of the yoke;
a ring-shaped first plate being coupled with a lower surface of the first magnet;
a plate-type second plate being coupled with an upper surface of the second magnet;
a first diaphragm whose outer periphery is fixed to a lower opening of the frame;
a second diaphragm whose outer periphery is fixed to an upper opening of the frame;
a ring-shaped first voice coil whose one end is fixed to the first diaphragm and other end is placed at a first magnetic gap formed between an inner peripheral surface of the first plate and an outer peripheral surface of the middle section of the yoke;
a second voice coil whose one end is fixed to the second diaphragm and other end is placed at a second magnetic gap formed between an inner peripheral surface of the second plate and an inner peripheral surface of the middle section of the yoke,
where the frame is integrated with the yoke in assembling the frame.

Besides, the present invention provides another loudspeaker including the following elements:
a hollow frame having opening sections at its upper side and lower side;
a hat-shaped yoke whose both ends are supported by an inner wall of the frame;
a ring-shaped first magnet being coupled with a lower surface of an outer periphery of the yoke;
a columnar second magnet being coupled with an inner bottom of a middle section of the yoke;
a ring-shaped first plate being coupled with a lower surface of the first magnet;
a plate-type second plate being coupled with an upper surface of the second magnet;
a first diaphragm whose outer periphery is fixed to a lower opening of the frame;
a second diaphragm whose outer periphery is fixed to an upper opening of the frame;
a ring-shaped first voice coil whose one end is fixed to the first diaphragm and other end is placed at a first magnetic gap formed between an inner peripheral surface of the first plate and an outer peripheral surface of the middle section of the yoke;
a second voice coil whose one end is fixed to the second diaphragm and other end is placed at a second magnetic gap formed between an inner peripheral surface of the second plate and an inner peripheral surface of the middle section of the yoke,
where the frame is integrated with an outer peripheral part of a connected-component which is formed by coupling the yoke with the first magnet and the first plate.

### BRIEF DESCRIPTION OF THE DRAWINGS

FIG. 1 is a sectional view of a loudspeaker in accordance with an exemplary embodiment of the present invention.

FIG. 2 is a perspective sectional view of the loudspeaker in accordance with the exemplary embodiment of the present invention.

FIG. 3 is a sectional view of a loudspeaker in accordance with another exemplary embodiment of the present invention.

FIG. 4 is a sectional view of a conventional loudspeaker.

### DETAILED DESCRIPTION OF THE PREFERRED EMBODIMENT

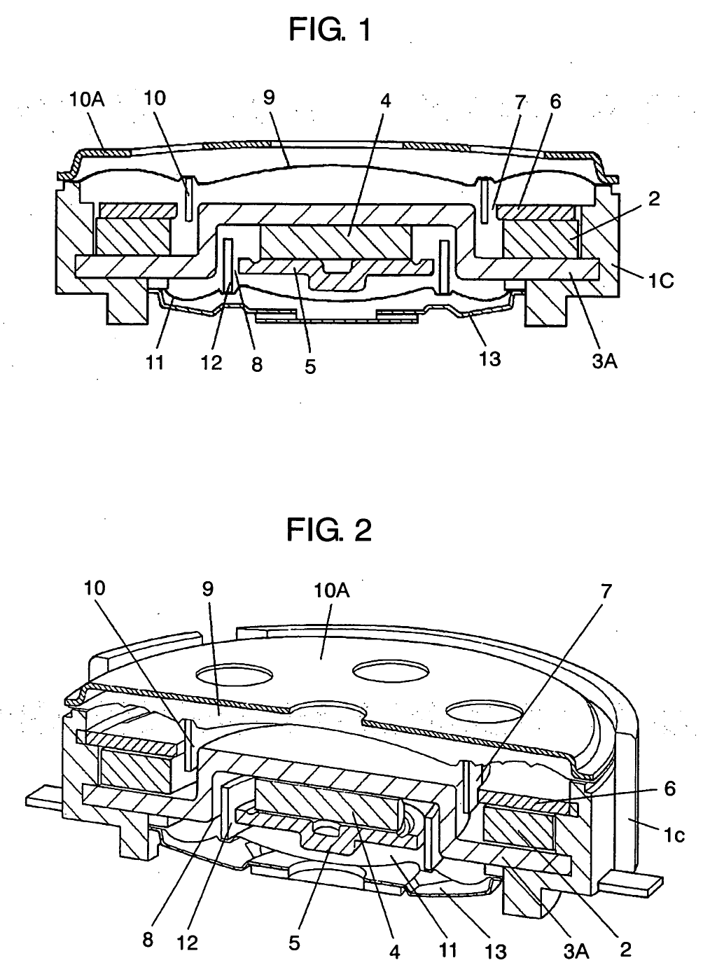

Exemplary embodiments of a loudspeaker in the present invention are demonstrated hereinafter with reference to FIGS. 1 through 3. Elements similar to those in the conventional art have the same reference marks, and the descriptions of those elements are omitted.

Magnetic material having high magnetic permeability and low coercive force is used as a yoke or plate in the present invention. For example, iron or the like is preferably used. In addition, magnet material having a large energy product is used as a magnet. A ferrite magnet, samarium-cobalt magnet or neodymium-base magnet is preferably used. The neodymium-base magnet having a large energy product is more preferably used from the point of view of downsizing and weight reduction of a loudspeaker. If necessary, magnetic material or magnet material may be treated by rustproof treatment.

A frame is molded by using resin material. Thermoplastic resin is preferably used because a curing process is unnecessary. For example, ABS or PBT is used. If heat-resisting properties are needed, thermoplastic resin having a glass transition temperature not less than 100° C. is more preferable.

As an example of resin material, high heat-resisting and -stiffness PA (i.e., polyamide, nylon-base resin) including glass can be used. The resin material needs proper fluidity in a mold for integrally molding with other kinds of material such as metal. Various additives may be used for improving fluidity.

### First Exemplary Embodiment

Different points between the present invention and the conventional art are described hereinafter with reference to FIGS. 1 and 2.

Hat-shaped yoke 3A is integrated with frame 1C by insert-molding in resin-molding of frame 1C. The positional relation between frame 1C and yoke 3A is determined by a mounting position of yoke 3A which is formed at a mold of frame 1C. As a result, a connecting error, which tends to be generated in assembling a conventional loudspeaker, is not generated.

First magnet 2, first plate 6, second magnet 4 and second plate 5 are coupled with an upper surface or a lower surface of yoke 3A using an adhesive in a same manner as the conventional art. At this time, because frame 1C and yoke 3A have been integrated with each other, variations in mounting positions of the plurality of magnets and plates mentioned above for the frame are reduced.

As a result, the quality of the loudspeaker can be kept high. In addition, because yoke 3A is integrated with frame 1C by insert-molding, conventional protruded section 1A, which is coupled with yoke 3, of an inner wall of frame 1 becomes unnecessary at frame 1C.

Therefore, this invention contributes to downsizing of a loudspeaker.

### Second Exemplary Embodiment

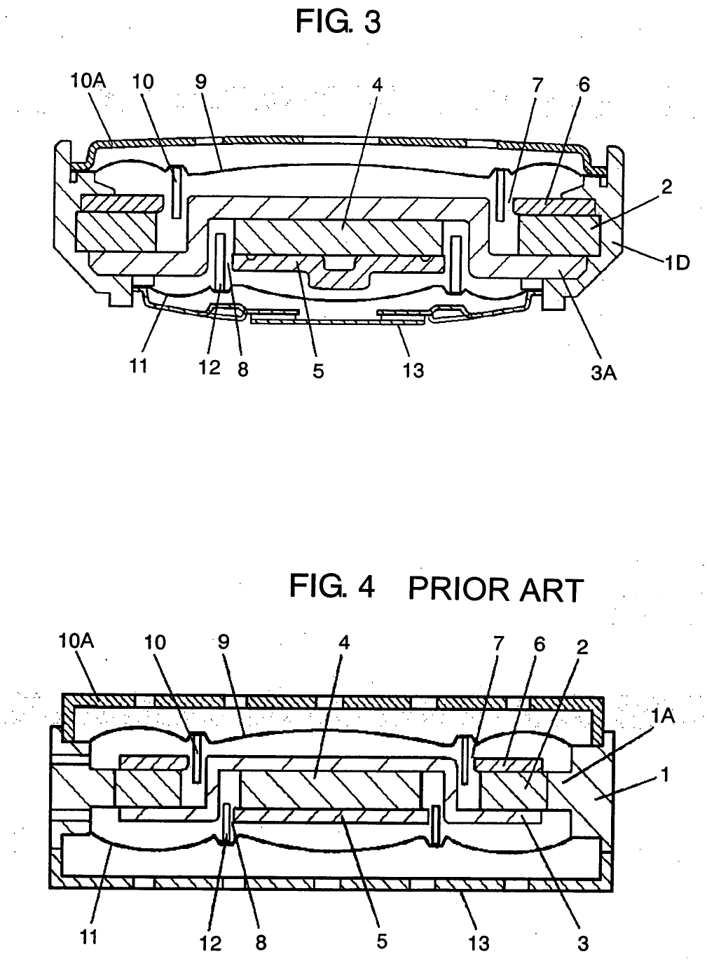

Different points between the present invention and the conventional art are described hereinafter with reference to FIG. 3.

First, a connected-component which is formed by coupling hat-shaped yoke 3A with first magnet 2 and first plate 6 by using an adhesive is prepared.

Next, frame 1D is molded of resin, and simultaneously, the connected-component and frame 1D are integrated with each other by using insert-molding.

Using the structure discussed above, frame 1D and yoke 3A are integrated with each other, so that a connecting error, which tends to be generated at the conventional structure, between frame 1D and yoke 3A is not generated.

Besides, because first plate 6 of first magnet 2 is integrated with frame 1D by using insert-molding, the number of processes decreases. Furthermore, space for yoke 3A incorporated in frame 1D is unnecessary, and the connected-component is buried in frame 1D, so that the loudspeaker as a whole can be downsized.

As a result, when the loudspeaker of the present invention is the same size as the conventional one, a magnetic circuit can be larger because of the downsizing of the loudspeaker. Therefore, its output can be improved.

A mounting surface of yoke 3A for a mold of frame 1D is set as a reference plane in insert-molding. Interval-accuracy between one diaphragm coupled with one opening side of frame 1D and the yoke can be improved as compared with interval-accuracy between other diaphragm coupled with other opening side and the yoke. In a word, one side of loudspeaker can be more stable than other side thereof in sound-pressure frequency characteristics.

To be more specific, in a case where a lower surface of yoke 3A is a mounting surface for a mold of frame 1D, an interval between second diaphragm 11 and the yoke only depends on assembling-accuracy of the mold of frame 1D. On the other hand, an interval between first diaphragm 9 and yoke 3A depends on assembling-accuracy of the mold of frame 1D and variations in a board thickness of yoke 3A.

In a loudspeaker which is employed as a receiver used by making the operator's ear close to the receiver, the operator recognizes variations in sound-pressure frequency characteristics. Therefore, such a problem can be avoided by using the loudspeaker of a side of second diaphragm 11 as a receiver. This characteristic can be applied to the first embodiment.

According to this embodiment, the characteristic is improved by using one of the upper surface of yoke 3A and the lower surface thereof as the mounting surface for the mold of frame 1D. The structure or method mentioned above can be also applied to the loudspeaker of the first embodiment.

According to the first and second embodiments, the hat-shaped yoke is described as a circular shape, however, other shapes such as an elliptic shape or track shape can be used.

### INDUSTRIAL APPLICABILITY

According to a loudspeaker of the present invention, a yoke is integrated with a frame by insert-molding the yoke in frame-molding. Therefore, variations in connecting the frame and the yoke are not generated, so that the loudspeaker having stable quality can be provided.

1. A loudspeaker comprising:
a hollow frame having opening sections at its upper side and lower side;
a hat-shaped yoke whose both ends are supported by an inner wall of the frame;
a ring-shaped first magnet being coupled with a lower surface of an outer periphery of the yoke;
a columnar second magnet being coupled with an inner bottom of a middle section of the yoke;
a ring-shaped first plate being coupled with a lower surface of the first magnet;
a plate-type second plate being coupled with an upper surface of the second magnet;
a first diaphragm whose outer periphery is fixed to a lower opening of the frame;
a second diaphragm whose outer periphery is fixed to an upper opening of the frame;
a ring-shaped first voice coil whose one end is fixed to the first diaphragm and other end is placed at a first magnetic gap formed between an inner peripheral surface of the first plate and an outer peripheral surface of the middle section of the yoke; and
a second voice coil whose one end is fixed to the second diaphragm and other end is placed at a second magnetic gap formed between an inner peripheral surface of the second plate and an inner peripheral surface of the middle section of the yoke,
wherein the frame is integrated with the yoke in assembling the frame.

2. A loudspeaker comprising:
a hollow frame having opening sections at its upper side and lower side;
a hat-shaped yoke whose both ends are supported by an inner wall of the frame;
a ring-shaped first magnet being coupled with a lower surface of an outer periphery of the yoke;
a columnar second magnet being coupled with an inner bottom of a middle section of the yoke;
a ring-shaped first plate being coupled with a lower surface of the first magnet;
a plate-type second plate being coupled with an upper surface of the second magnet;
a first diaphragm whose outer periphery is fixed to a lower opening of the frame;
a second diaphragm whose outer periphery is fixed to an upper opening of the frame;
a ring-shaped first voice coil whose one end is fixed to the first diaphragm and other end is placed at a first magnetic gap formed between an inner peripheral surface of the first plate and an outer peripheral surface of the middle section of the yoke; and
a second voice coil whose one end is fixed to the second diaphragm and other end is placed at a second magnetic gap formed between an inner peripheral surface of the second plate and an inner peripheral surface of the middle section of the yoke,
wherein the frame is integrated with an outer peripheral part of a connected-component which is formed by coupling the yoke with the first magnet and the first plate.

3. The loudspeaker of claim 1,
wherein at least one of an upper surface of the yoke and a lower surface thereof is integrated as a reference plane in mounting for a mold of the frame.

4. The loudspeaker of claim 2,
wherein at least one of an upper surface of the yoke and a lower surface thereof is integrated as a reference plane in mounting for a mold of the frame.
